(19) United States
(12) Patent Application Publication
(10) Pub. No.: US 2026/0042019 A1
(43) Pub. Date: Feb. 12, 2026

(54) RESTRICTING VIDEO GAME HELP SESSIONS

(71) Applicant: Microsoft Technology Licensing, LLC, Redmond, WA (US)

(72) Inventors: Monica Ann ADJEMIAN, Los Angeles, CA (US); Jennifer R. GURIEL, Kirkland, WA (US); Gershom PAYZER, Redmond, WA (US)

(73) Assignee: Microsoft Technology Licensing, LLC, Redmond, WA (US)

(21) Appl. No.: 18/798,096

(22) Filed: Aug. 8, 2024

(51) Int. Cl. A63F 13/73

(52) U.S. Cl. CPC A63F 13/73

(57) ABSTRACT

The disclosed concepts relate to managing help sessions in video games. A system or method receives control inputs from a helper during a help session in a video game. The system or method obtains a game state of the video game and determines whether to provide the control inputs to the video game based on the game state. In at least one instance, the system or method at least temporarily prevents the video game from receiving a particular control input.

### CROSS-REFERENCE TO RELATED APPLICATIONS

This application is related to, and incorporates by reference in their entirety, the following: U.S. patent application Ser. No. ______ (Attorney Docket No. 057846-US01), U.S. patent application Ser. No. ______ (Attorney Docket No. 502018-US01), U.S. patent application Ser. No. ______ (Attorney Docket No. 502019-US01), U.S. patent application Ser. No. ______ (Attorney Docket No. 502020-US01), and U.S. patent application Ser. No. ______ (Attorney Docket No. 502022-US01).

### BACKGROUND

Video game players often encounter difficult gaming situations, such as difficult enemies, difficult items to find, difficult levels to complete, etc. In some cases, video game players will seek the assistance of other video game players, e.g., by posting on online forums to get suggestions from other members of the video gaming community to overcome difficult parts of a given game. In other cases, video game players consult online videos of other players demonstrating how to overcome difficult gaming situations. However, these techniques are rather rudimentary.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to video game help sessions. One example entails a computer-implemented method or technique that can include receiving control inputs from a helper during a help session for a video game. The method or technique can also include obtaining a game state of the video game. The method or technique can also include determining whether to provide the control inputs to the video game based on the game state. The method or technique can also include in at least one instance, at least temporarily preventing the video game from receiving a particular control input received from the helper.

Another example entails a system that includes processing resources and storage resources. The storage resources can store computer-readable instructions which, when executed by the processing resources, cause the processing resources to receive control inputs from a helper during a help session for a video game. The computer-readable instructions can also cause the system to obtain a game state of the video game. The computer-readable instructions can also cause the system to determine whether to provide the control inputs to the video game based on the game state. The computer-readable instructions can also cause the system to in at least one instance, at least temporarily prevent the video game from receiving a particular control input received from the helper.

Another example includes a computer-readable storage medium storing computer-readable instructions which, when executed by a hardware processing unit cause the hardware processing unit to perform acts. The acts can include receiving control inputs from a helper during a help session for a video game. The acts can also include obtaining a game state of the video game. The acts can also include determining whether to provide the control inputs to the video game based on the game state. The acts can also include in at least one instance, at least temporarily preventing the video game from receiving a particular control input received from the helper.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example machine learning model, consistent with some implementations of the present concepts.

FIG. 2 illustrates an example computer vision model, consistent with some implementations of the present concepts.

FIG. 3 illustrates an example generative language model, consistent with some implementations of the present concepts.

FIG. 4 shows some examples of gameplay sequences, consistent with some implementations of the present concepts.

FIGS. 5A, 5B, 5C, 5D, 5E, 5F, 5G, 5H, 5I, 5J, 5K, and 5L illustrate an illustrative graphic user interface (GUI) of a video game, consistent with some implementations of the present concepts.

FIGS. 6A and 6B are illustrations of GUIs displaying a video game, consistent with some implementations of the present concepts.

FIG. 7 is a block diagram of a workflow that can restrict or otherwise manage help sessions within a video game, consistent with some implementations of the present concepts.

FIG. 8 illustrates an example system in which the present concepts can be employed.

FIG. 9 illustrates an example computer-implemented method, consistent with some implementations of the present concepts.

### DETAILED DESCRIPTION

### Overview

As noted above, video game players sometimes seek help from other video game players to overcome in-game difficulties, often by consulting online forums or videos. However, while this type of help is widely available, it takes a great deal of effort for users to seek out the assistance they need to accomplish their goal. Furthermore, these techniques may take the video game players out of the gaming experience while they search for external help content. Another alternative is to allow a helper to temporarily take over a video game to assist another video game player, but this can sometimes lead to negative consequences depending on the actions of the helper.

The disclosed implementations aim to address these issues by providing help sessions for video games that can be dynamically restricted. The help session can allow a selectable amount of control to a helper. The helper temporarily takes over control of the video game until the help session is completed. Actions taken by the helper can be dynamically restricted based on a game state and other factors. The helper can be another human game player or a trained machine learning model. Potential actions of the other game player, or helper, are subject to restriction under certain conditions relating to the state of the game, the nature of the action, or the current and past effectiveness of the helper.

### Machine Learning Overview

There are various types of machine learning frameworks that can be trained to perform a given task, such as detecting triggering conditions and ending conditions for help sessions. Support vector machines, decision trees, random forests, and neural networks are just a few examples of suitable machine learning frameworks that have been used in a wide variety of other applications, such as image processing and natural language processing.

A support vector machine is a model that can be employed for classification or regression purposes. A support vector machine maps data items to a feature space, where hyperplanes are employed to separate the data into different regions. Each region can correspond to a different classification. Support vector machines can be trained using supervised learning to distinguish between data items having labels representing different classifications.

A decision tree is a tree-based model that represents decision rules using nodes connected by edges. Decision trees can be employed for classification or regression and can be trained using supervised learning techniques. Multiple decision trees can be employed in a random forest, which significantly improves the accuracy of the resulting model relative to a single decision tree. In a random forest, the individual outputs of the decision trees are collectively employed to determine a final output of the random forest. For instance, in regression problems, the output of each individual decision tree can be averaged to obtain a final result. For classification problems, a majority vote technique can be employed, where the classification selected by the random forest is the classification selected by the most decision trees.

A neural network is another type of machine learning model that can be employed for classification or regression tasks. In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs.

Various training procedures can be applied to learn the edge weights and/or bias values of a neural network. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, decoding, alignment, prediction, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned, e.g., individualized tuning to one or more particular users. Note that two trained models can share the same model structure and yet have different values for the internal parameters, e.g., if the two models are trained on different training data or if there are underlying stochastic processes in the training process.

### Terminology

The term “current game state,” or just “game state,” as used herein, refers to the current location of the character, items accrued in their inventory, health status, etc. Game state can be explicitly provided by a video game and/or inferred from output of the video game. For instance, computer vision models and/or optical character recognition techniques can be applied to the video output of a video game to determine aspects of game state.

The term “prior gameplay data,” as used herein, refers to various types of data associated with gameplay of a video game. Prior gameplay data can include gameplay sequences, e.g., inputs to a video game and/or outputs of the video game during prior gaming sessions. Prior gameplay data can also include communication logs relating to the game, such as in-game chat or voice sessions or external data such as forum posts regarding a particular game. Prior gameplay data can also include platform data collected by a video gaming platform, such as an online game playing service utilized by multiple video games or an operating system that runs on a gaming console. Prior gameplay data can also include instrumented game data that can be stored by the video game itself during execution for subsequent evaluation. Note that prior gameplay data can include very recent gameplay data obtained in real-time from live video game play.

A “help session” is an experience that occurs to assist a video game player with a particular portion of a video game. For instance, a help session can include a tutorial, e.g., text, chat, or video based. A help session can also include transferring control of a video game session to another game player that temporarily takes over control of a video game until the help session is completed. The other game player can be a human being or a trained machine learning model.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as ChatGPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a multi-modal generative model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include CLIP models, certain GPT variants such as GPT-4o, Gemini, etc.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Neural Network

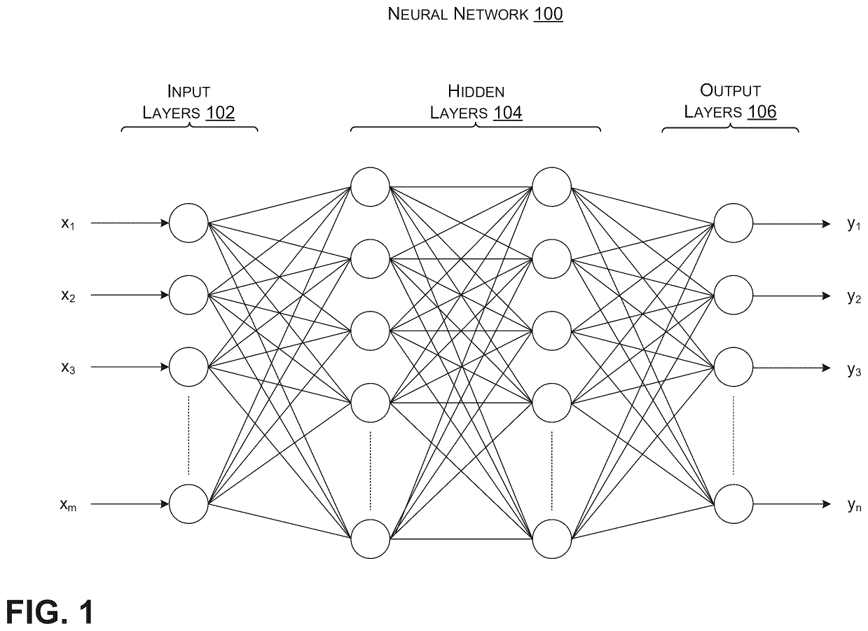

FIG. 1 shows a deep neural network 100 with input layers 102, hidden layers 104, and output layers 106. The input layers can receive features x₁ through xₘ. For instance, the features can relate to prior gameplay data for one or more video games and can include features relating to gameplay sequences by one or more players, features relating to communication logs from players discussing the video game, features relating to platform data collected by a gaming platform that executes the video game, and/or game data (e.g., telemetry) collected by the video game itself when executing.

The input layers can feed into the hidden layers 104. The hidden layers feed into the output layers 106. The output layers can output values y₁ through yₙ. For instance, the output values can characterize any aspect of video game play at any point during the video game. In some cases, the output values are calculated using a regression approach, and in other cases using a classification approach.

In a regression approach, the neural network 100 is used to estimate a relationship between independent variables and dependent variables, which may include actions of a helper. The dependent variable, or response variable, can be used to predict or otherwise identify restricted actions. For instance, a neural network could be trained to produce a numerical trust score for a control input based on input features relating to the control input, video game state, and/or the history of the helper. The control input can be restricted or allowed depending on whether the trust score exceeds a threshold. In a classification approach, the neural network can be trained to produce Boolean values indicating whether a given input is trusted or untrusted (e.g., should be restricted) based on similar input features.

Neural network 100 is shown with a general architecture that can be modified depending on the task being performed by the neural network. For instance, neural networks can be implemented with convolutional layers to implement a computer vision model or as a transformer encoder/decoder architecture to implement a generative language or multi-modal generative. Neural networks can also have recurrent layers such as long short-term memory networks, gated recurrent units, etc.

### Example Computer Vision Model

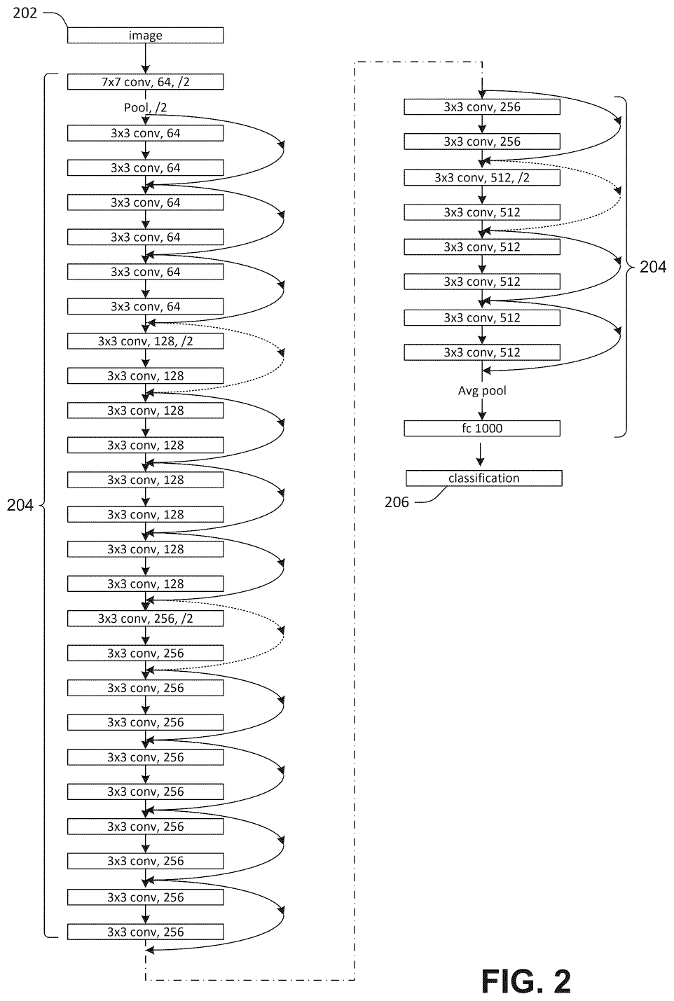

While FIG. 1 illustrates a general architecture of a neural network, FIG. 2 illustrates a particular example of a neural network model for computer vision. For instance, FIG. 2 shows an image 202 being classified by a computer vision model 204 to determine an image classification 206. For instance, the image can include part or all of a video frame output by a video game, and computer vision model 204 can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters. If the feature map size is halved by a given convolutional layer (as shown by “/2” in FIG. 2), then the number of filters can be doubled to preserve the time complexity across layers.

After the image has been processed using a series of convolutional layers, the image is processed in a global average pooling layer. The output of the pooling layer is processed with a 1000-way fully connected layer with softmax. The fully connected layer can be used to determine a classification, e.g., an object category of an object in image 202.

The respective layers within computer vision model 204 can have shortcut connections which perform identity operations:

$$y = F ( x , \{ {W}_{i} \} ) + x \qquad ( 1 )$$

where x and y are the input and output vectors of the layers involved and F(x,{Wᵢ}) represents the residual mapping to be learned. In some connections the dimensions increase across layers (shown as dotted lines in FIG. 2). In these cases, the following projection can be employed to match the dimensions via 1×1 convolutions:

$$y = F ( x , \{ {W}_{i} \} ) + {W}_{s} x \qquad ( 2 )$$

In some implementations, computer vision model 204 can be pretrained on a large dataset of images, such as ImageNet. Such a general-purpose image database can provide a vast number of training examples that allow the model to learn weights that allow generalization across a range of object categories. Said another way, computer vision model 204 can be pretrained in this fashion.

After pretraining, computer vision model 204 can be tuned on another, smaller dataset for categories of interest. For instance, tuning datasets can be provided for specific video games and genres of video games, among other variables. For instance, the computer vision model can be tuned to detect objects such as menus for accessing inventory of characters, status of health bars, instances where video game characters die, crash, or experience other negative in-game consequences, etc. The computer vision model can also detect other objects in the video output, e.g., to provide context such as in-game locations of a character.

### Example Decoder-Based Generative Language Model

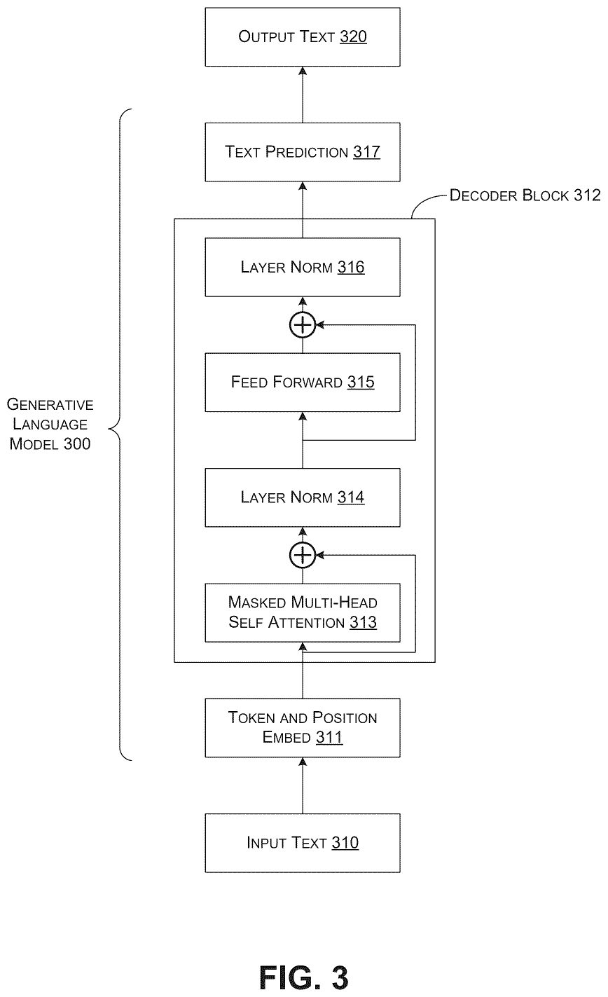

While FIG. 1 illustrates a general architecture of a neural network, FIG. 3 illustrates a particular example of a neural network model for language generation. Specifically, FIG. 3 illustrates an exemplary generative language model 300 (e.g., a transformer-based decoder) that can be employed using the disclosed implementations. The generative language model 300 is an example of a machine learning model that can be used to perform one or more natural language processing tasks that involve generating text, as discussed more below. For the purposes of this document, the term “natural language” means language that is normally used by human beings for writing or conversation.

The generative language model 300 can receive input text 310, e.g., a prompt from a user or a prompt generated automatically by machine learning using the disclosed techniques. For instance, the input text can include words, sentences, phrases, or other representations of language. The input text can be broken into tokens and mapped to token and position embeddings 311 representing the input text. Token embeddings can be represented in a vector space where semantically similar and/or syntactically similar embeddings are relatively close to one another, and less semantically similar or less syntactically similar tokens are relatively further apart. Position embeddings represent the location of each token in order relative to the other tokens from the input text.

The token and position embeddings 311 are processed in one or more decoder blocks 312. Each decoder block implements masked multi-head self-attention 313, which is a mechanism relating different positions of tokens within the input text to compute the similarities between those tokens. Each token embedding is represented as a weighted sum of other tokens in the input text. Attention is only applied for already-decoded values, and future values are masked. Layer normalization 314 normalizes features to mean values of 0 and variance to 1, resulting in smooth gradients. Feed forward layer 315 transforms these features into a representation suitable for the next iteration of decoding, after which another layer normalization 316 is applied. Multiple instances of decoder blocks can operate sequentially on input text, with each subsequent decoder block operating on the output of a preceding decoder block. After the final decoding block, text prediction layer 317 can predict the next word in the sequence, which is output as output text 320 in response to the input text 310 and also fed back into the language model. The output text can be a newly generated response to the prompt provided as input text to the generative language model.

The generative language model 300 can be trained using techniques such as next-token prediction or masked language modeling on a large, diverse corpus of documents. For instance, the text prediction layer 317 can predict the next token in a given document, and parameters of the decoder block 312 and/or text prediction layer can be adjusted when the predicted token is incorrect. In some cases, a generative language model can be pretrained on a large corpus of documents (Radford, et al., “Improving language understanding by generative pre-training,” 2018). Then, a pretrained generative language model can be tuned using a reinforcement learning technique such as reinforcement learning from human feedback (“RLHF”). In other examples, a generative language model could be tuned using training data from a specific video game or games from a particular genre to determine when specific in-game consequences are likely to result from received control inputs in specific game states, as discussed more below.

In the context of FIG. 2, objects detected by the computer vision model 204 can be passed on to generative language model 300 as one type of game state. The generative model 300 can be tuned to learn whether video game inputs from a helper are likely to result in negative in-game consequences given the game state. As one example, some genres of video games tend to have health status bars or important, powerful enemies (“bosses”), and computer vision model 204 could be tuned to detect health status and/or boss fight scenarios using training data from multiple games from a particular genre. For instance, the training data could include video frames with associated labels, e.g., either manually labeled health bars or boss fights or implicit labels obtained from user chat logs, forum discussions, etc. The generative language model could decide that a help session could be ended when a health status level falls below a threshold. In other cases, the generative language model could be tuned to detect that a particular input is unusual given a current video game state, which could serve as a basis for restricting that input.

### Example Help Session Training Sequences

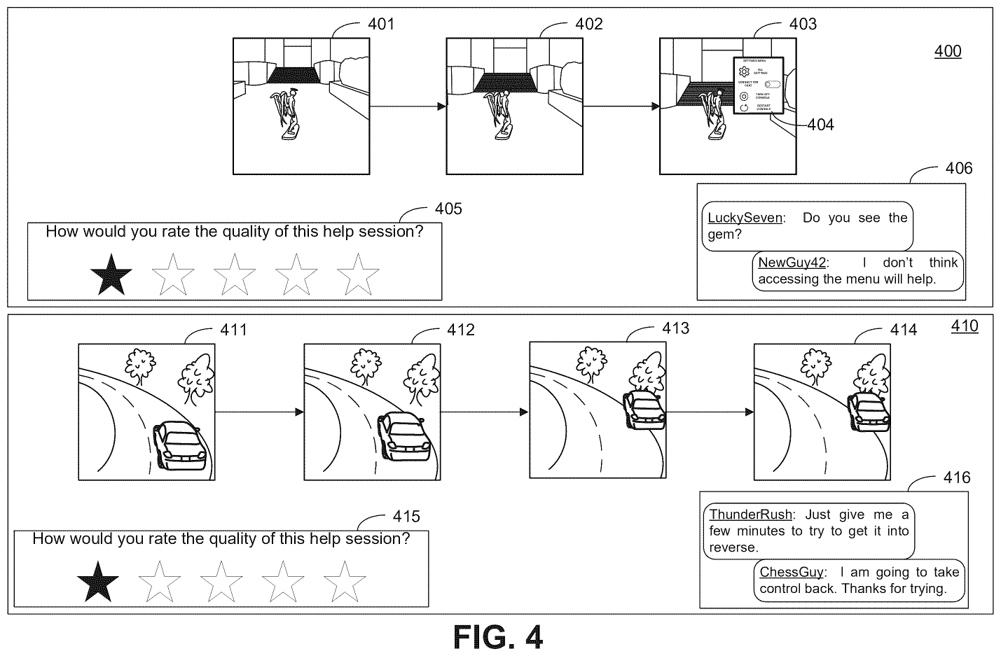

FIG. 4 shows example gameplay sequences 400 and 410 associated with help sessions that ended with negative results. In gameplay sequence 400, the illustrative adventure video game involves controlling a character riding a hoverboard, and one of the in-game goals involves finding a rare gem. In the gameplay sequence 400, the character moves forward through frame 401, frame 402, and frame 403 looking for a gem while being controlled by a helper named LuckySeven. At frame 403, LuckySeven opens the menu 404. NewGuy42 decides that this action is not appropriate for finding the gem, takes back control of the video game, and gives a help session rating 405 of one star to LuckySeven. A chat log 406 indicates NewGuy42 was frustrated by the help session. As described herein, the rating 405 and chat log 406 are used to make future assessments of LuckySeven as a helper, and also of control inputs accessing the menu 404 in the current game state (e.g., when the character is near the turn to find the game). For example, the assessments can be used in consideration of restricting LuckySeven from control inputs in future help sessions. In addition, game state depicted in frame 401, frame 402, and frame 403 along with concurrent control inputs received from LuckySeven during the help session can be used to train a machine learning model to recognize that a future help session with similar state and control inputs is not going well, and should be automatically restricted and/or terminated.

The game sequence 410 of FIG. 4 shows an example of a help session involving a racing video game. The racing video game involves controlling a car driving along a course. Incorrectly navigating a turn can result in crashing into a tree. In the depicted scenario, the helper is unable or unwilling to avoid crashing and unnecessarily delays enjoyment of the video game. More specifically, the gameplay sequence 410 depicts a car driven on a virtual course in frame 411, frame 412, frame 413, and frame 414. During the sequence, the car has been controlled via a help session by a helper, ThunderRush. At frame 413, ThunderRush crashes into a tree. ThunderRush is unable or unwilling to back the car up and return to the track at frame 414. In response to the prolonged inaction of the helper, ChessGuy takes back control of the video game. ChessGuy gives a help session rating 415 of one star to ThunderRush, and a chat log 416 indicates ChessGuy was frustrated with the delay caused by the helper. Game sequence 410 can be used as a basis for restricting help sessions conducted by ThunderRush in the future. Furthermore, game state depicted in frame 411, frame 412, frame 413, frame 413, and frame 414 along with concurrent control inputs received from ThunderRush can be used to train a machine learning model to recognize that a future help session with similar state and control inputs is not going well, and should be automatically restricted and/or terminated.

Note that FIG. 4 illustrates only two examples of help session training sequences. In practice, many help session training sequences may be available representing a wide range of video game scenarios from different video games controlled by different helpers. In addition, some implementations can also employ help sessions with positive results as training data, e.g., to identify control inputs that should not be restricted during a help session.

### First Example of Help Session Restriction

The help session training sequences depicted above are just a few examples of how existing help sessions and reviews can be employed to learn how to restrict inputs in future help sessions. For instance, help session training sequences could be employed to learn that helpers should be prevented from purchasing inventory or changing game settings, e.g., if players being helped tend to give those help sessions negative ratings. In other case, instead of training a machine learning model to learn that inventory purchases or game setting modifications should be restricted, rules could be defined for restricting purchases and/or changes to game settings. The following describes a user experience that could occur when an inventory purchases and/or game setting modifications are restricted either by rule or by a machine learning model.

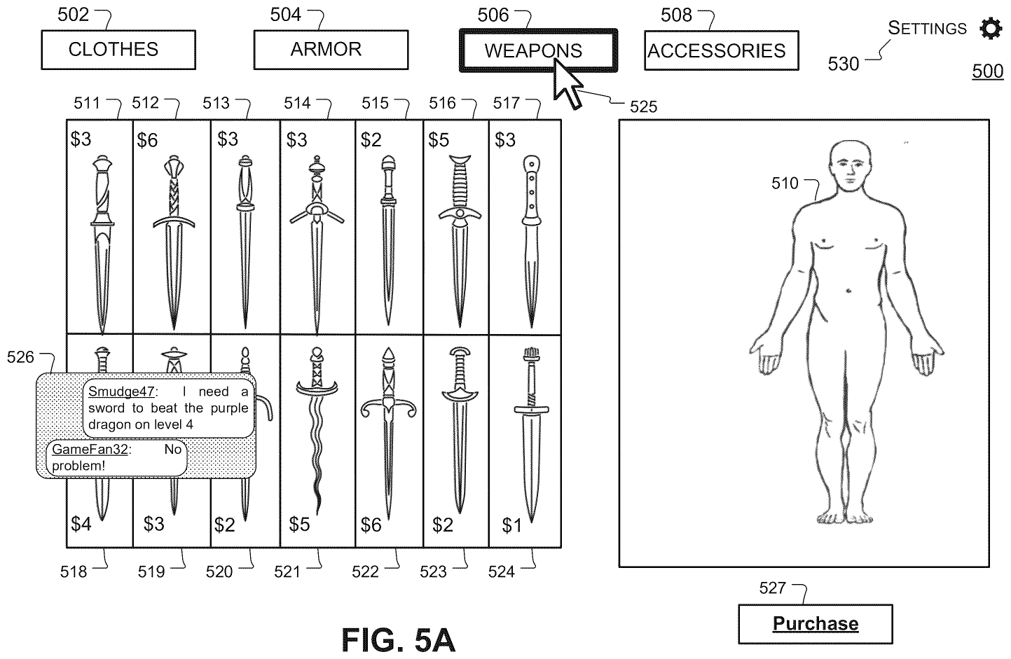

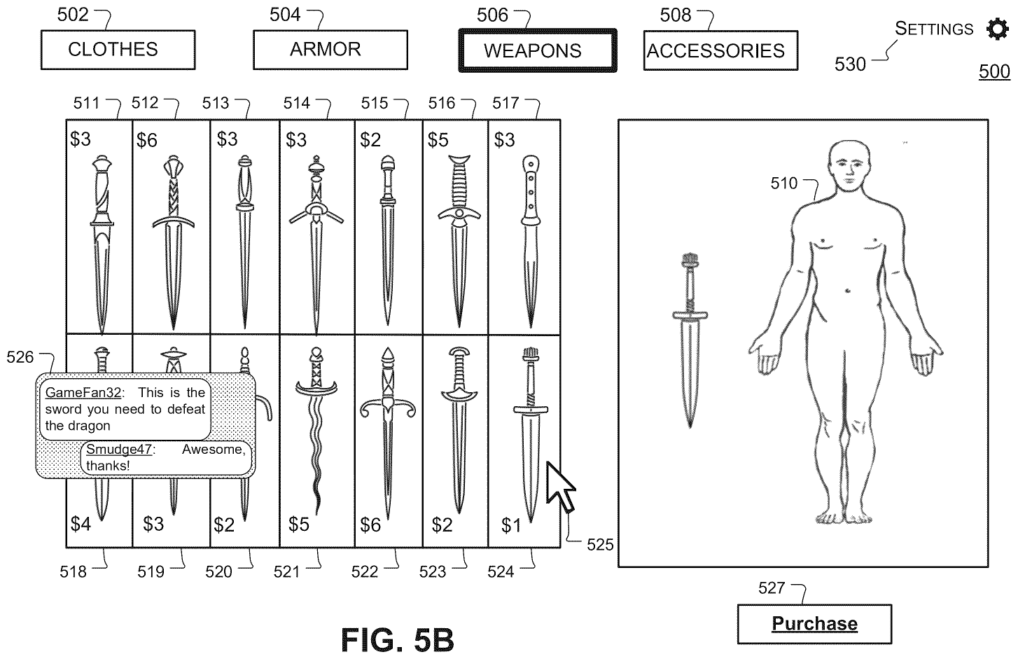

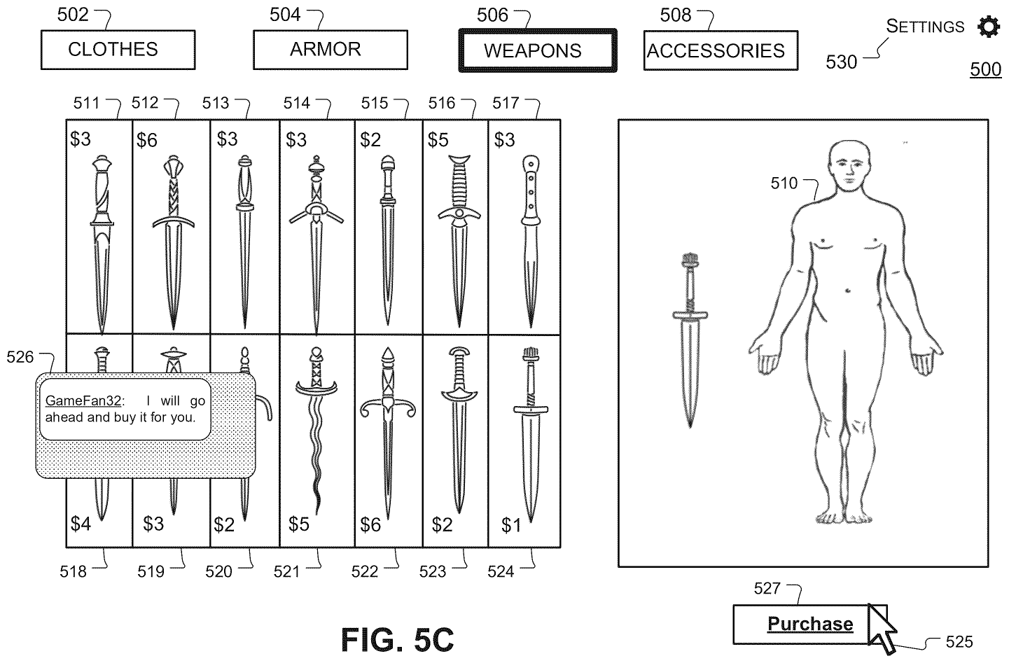

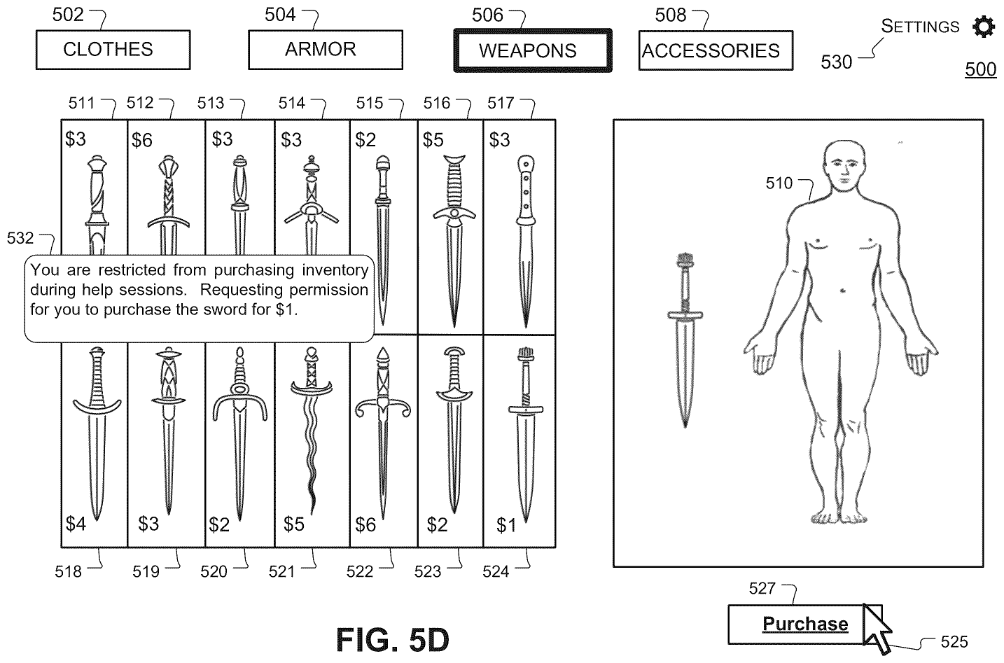

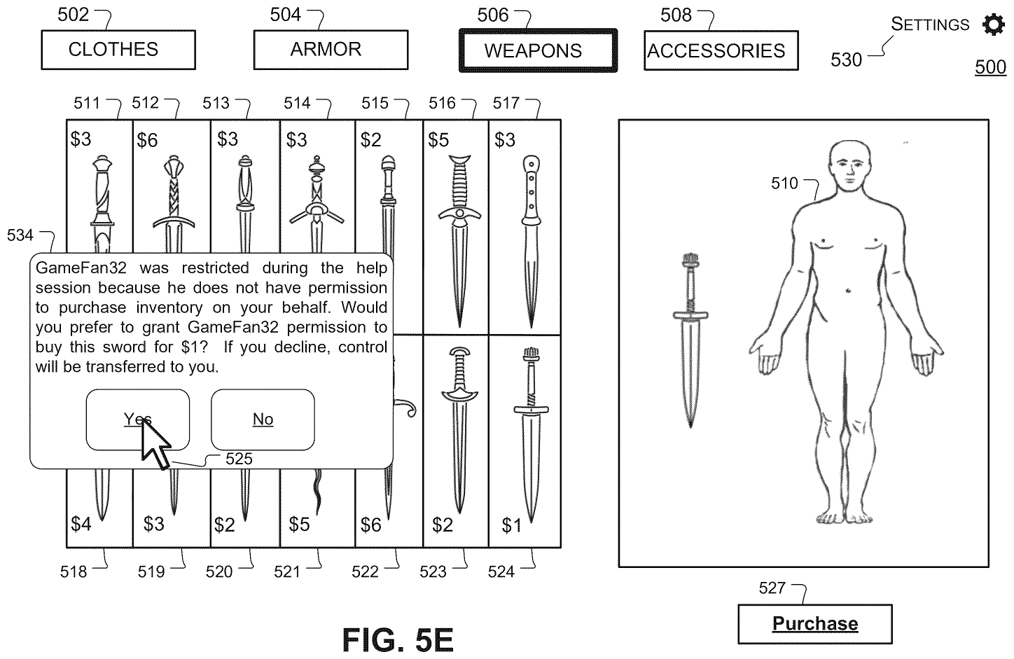

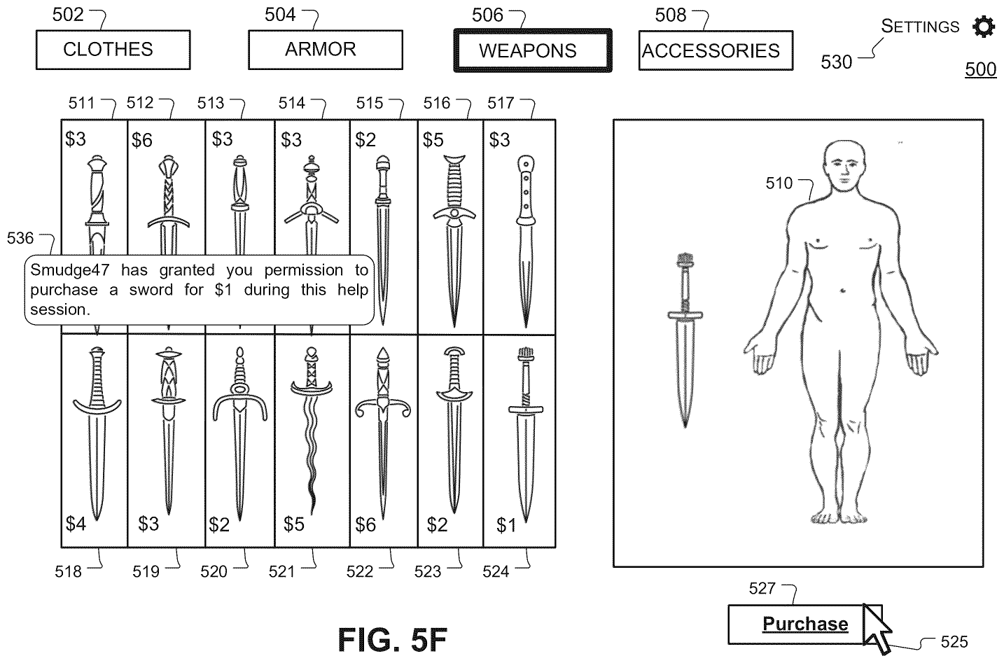

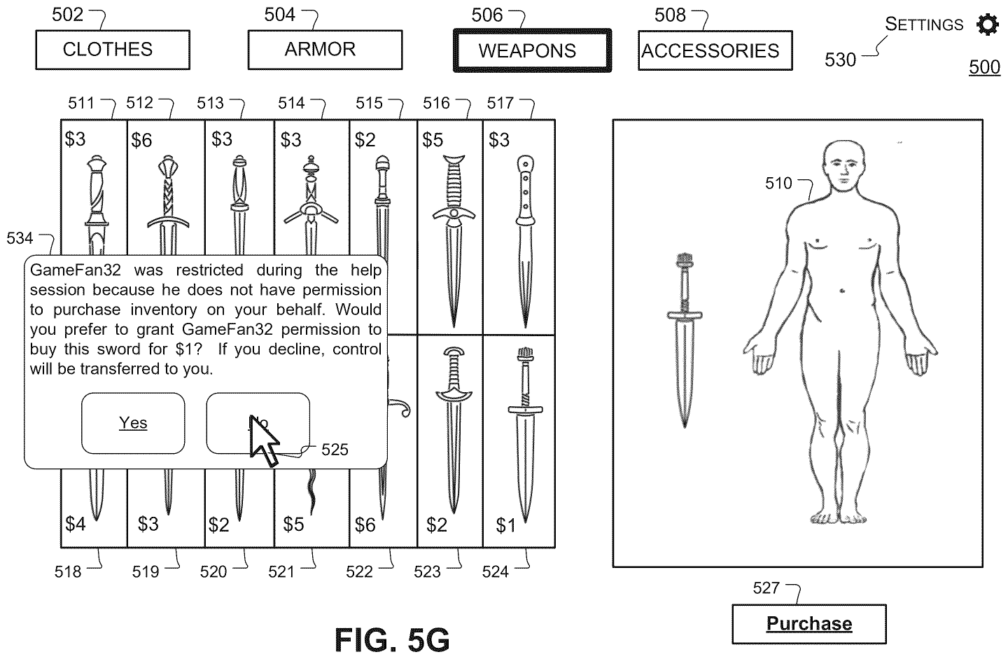

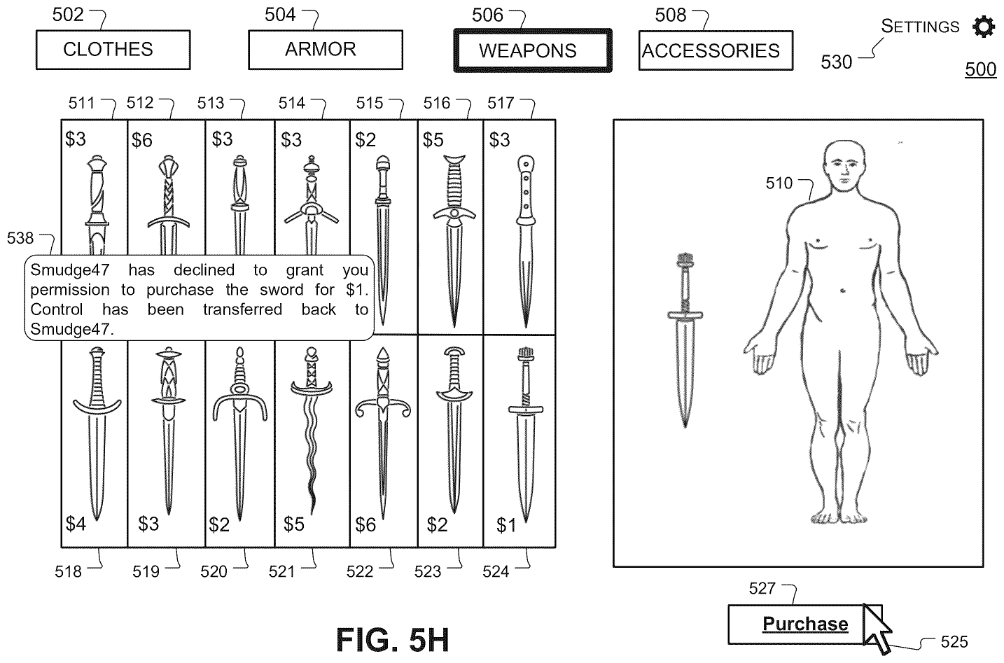

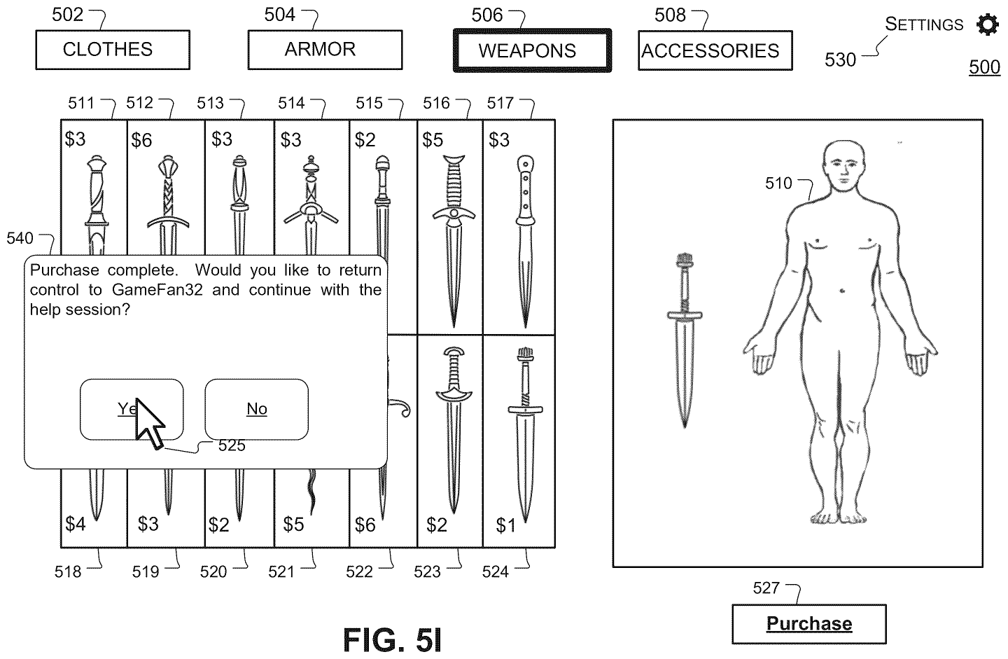

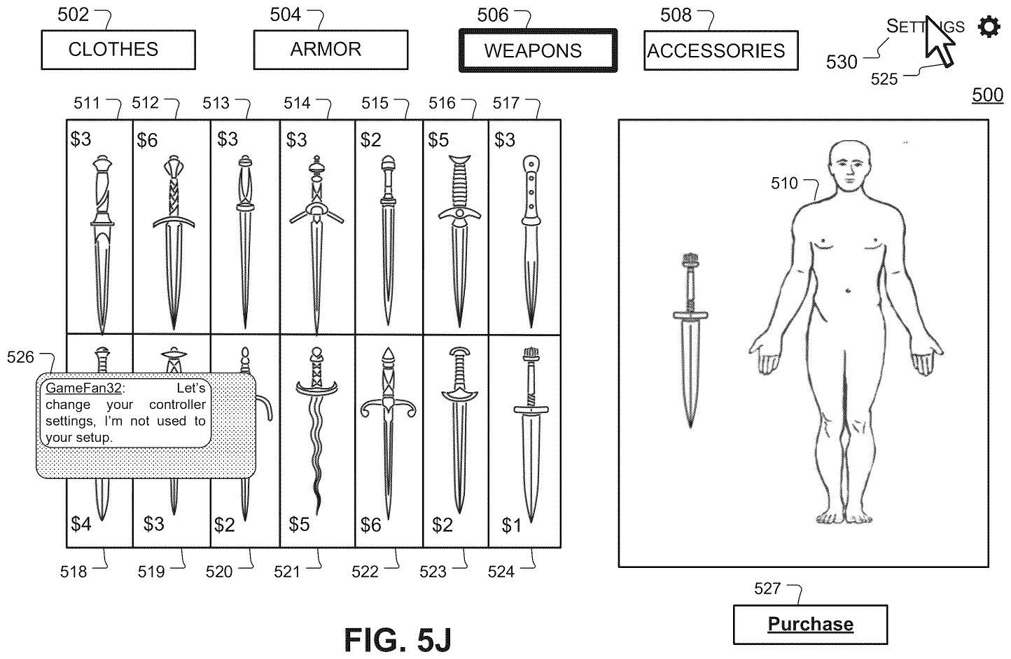

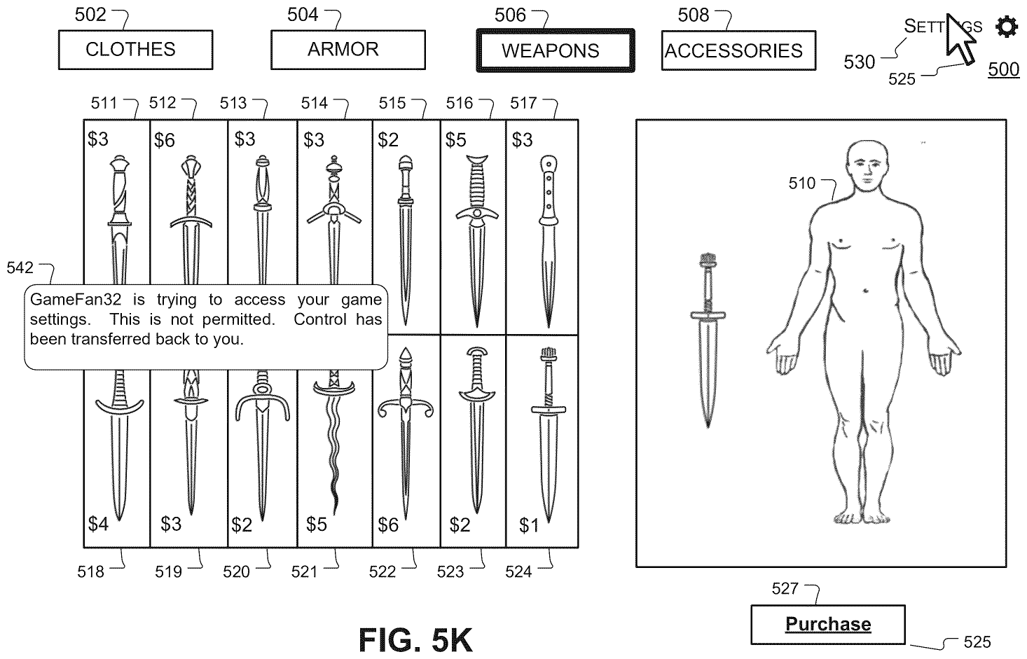

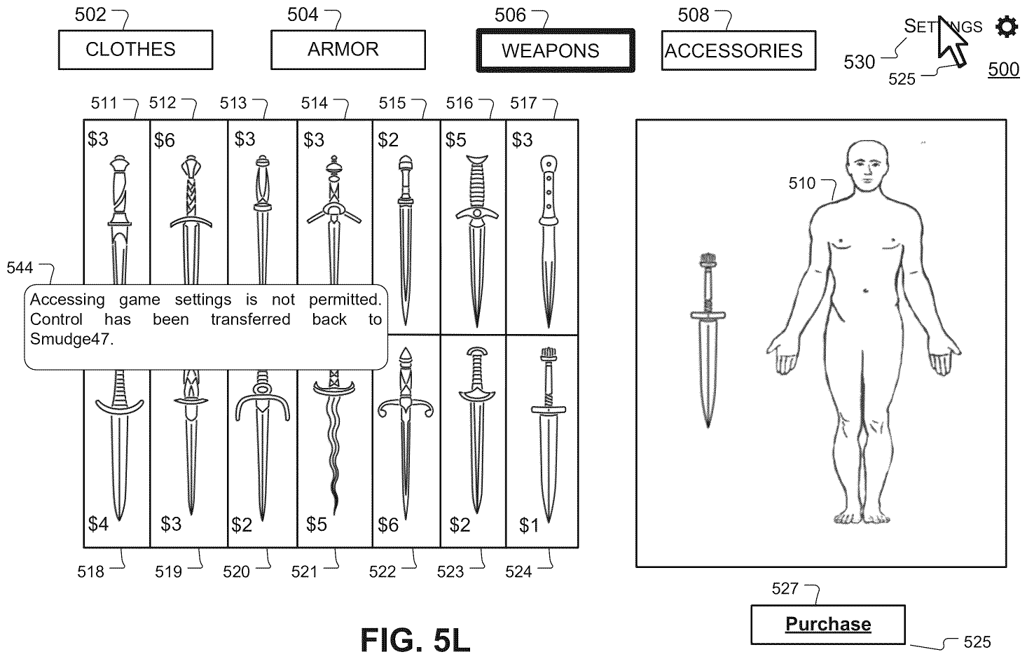

FIG. 5A shows an illustrative GUI 500 of a video game used by a game player (Smudge47) to equip their character with items found within an adventure game. Using the GUI, the game player can maintain an inventory for a character in which clothes button 502, armor button 504, weapons button 506, and other accessories button 508 allow various game items to be collected and added to the inventory of a character. The game player can review items within the player's inventory and equip the character with an item appropriate to the current game situation. The GUI 500 provided in FIG. 5A shows a “paper-doll” view of the character 510 that can be updated as inventory items are added.

Assume that Smudge47 has selected the weapons button 506 and seeks to purchase from a collection of available swords—sword 511, sword 512, sword 513, sword 514, sword 515, sword 516, sword 517, sword 518, sword 519, sword 520, sword 521, sword 522, sword 523, and/or sword 524. As shown in FIG. 5A, each of the swords is associated with a purchase price. The price in some implementations is paid with game currency, while other games permit purchases using real financial transactions.

Further, assume that Smudge47 is not certain which sword to purchase to defeat a particular dragon in the game, and requests help. A help session is initiated with a helper named GameFan32, who takes over control of the game starting with the GUI in the state shown in FIG. 5A. A cursor is located over weapons button 506, which is the last location of the cursor when controlled by Smudge47. A chat dialog 526 appears and Smudge47 explains to GameFan32 that they want help finding a sword to defeat a purple dragon on level 4. Note also that the GUI 500 includes a settings menu 530, discussed more below. Assume that both Smudge47 and GameFan32 have the same view of GUI 500 unless otherwise indicated below.

The example continues with FIG. 5B, where GameFan32 moves the cursor 525 over the sword 524. This is a navigational input that does not actually cause an in-game transaction, and is not restricted in this example. Chat dialog 526 is updated with GameFan32 explaining that this sword is the sword needed to defeat the dragon.

The example continues with FIG. 5C, where GameFan32 moves the cursor 525 over a purchase button 527. Chat dialog 526 is updated with GameFan32 stating that they will purchase the sword for Smudge47. However, for this example, assume that either a predefined rule or machine learning model is invoked that restricts GameFan32 from making a purchase. In other words, while navigational inputs to the various inventory items are allowed during the help session, inputs directed to actually purchasing items are restricted during the help session.

Continuing with the example, both GameFan32 and Smudge47 can be notified of the restriction. GameFan32 can be shown GUI 500 as shown in FIG. 5D, where a message 532 informs GameFan32 that the attempted purchase has resulted in the restriction. Smudge47 can be shown GUI 500 as shown in FIG. 5E, where a message 534 prompts Smudge47 with an option to remove the restriction for the present help session and allow GameFan32 to actually make the purchase. An affirmative response from Smudge47 can allow GameFan32 to purchase the sword. This is illustrated in FIG. 5F, which shows GUI 500 as presented to GameFan32 with a message 536 indicating that Smudge47 has granted permission for GameFan2 to purchase the sword.

Otherwise, as shown in FIG. 5G, Smudge47 can decline the option to grant GameFan32 permission to make the purchase, which can also result in Smudge47 retaining control of the game. As shown in FIG. 5H, GameFan32 can be shown a message 538 indicating that permission was denied. Next, assume Smudge47 completes the purchase themselves while having control of the game. As shown in FIG. 5I, a message 540 informs Smudge47 that they can return control to GameFan32 now that they have completed the purchase. A corresponding message (not shown) can also be shown to GameFan32 indicating that they have regained control.

Note that while prompts are employed in the above examples to allow the helpee to transfer control to or from the helper, other techniques can be employed. For instance, a designated sequence of control inputs from a video game controller or keyboard, a spoken or typed keyword or phrase, and/or a designated gesture could be employed by the helpee to take control of the game from the helper. The helpee could use the same or a different designated sequence of control inputs, spoken or typed keyword or phrase, and/or gesture to return control to the helper. In some cases, another designated sequence of control inputs can be employed for the helpee to terminate the help session, e.g., if the helpee decides that the helper is not assisting in a useful manner and wishes to simply end the help session.

The above examples illustrate how control can be selectively transferred back and forth between a helper and helpee during a help session. Not only does this allow for cooperative behavior between the helpee and the helper during the help session, it also allows for implementing functionality with restrictions that can be overridden by the helpee. In other cases, however certain functionality can be restricted without the option for the helpee to override the restriction during a help session.

For instance, in FIG. 5J, GameFan32 attempts to access settings menu 530. Chat dialog 526 indicates that GameFan32 communicates this to Smudge47. As shown in FIG. 5K, Smudge47 can be shown a message 542 that indicates that accessing the game settings is not permitted, and control is now returned to Smudge47. As shown in FIG. 5L, GameFan32 can be shown a message 544 indicating this as well. Note that, in this example, no override option is provided to allow GameFan32 to access the game settings.

In other implementations, game settings can be modified during help sessions (e.g., if accepted by the helpee) but other types of information can be restricted without the option for the helpee to override the restriction. For instance, viewing or modifying of private information such as financial information, friend information, names, dates of birth, locations, etc. can be restricted during help sessions without the possibility of being overridden. In some cases, even when the helpee has control of the video game, the helpee can be prevented from accessing such information to prevent this information from being inadvertently shared with the helper. In other cases, the helpee can be permitted to access such information during help sessions but image processing techniques can be employed to mask out sensitive information in the output sent to the helper.

### Second Example of Help Session Restriction

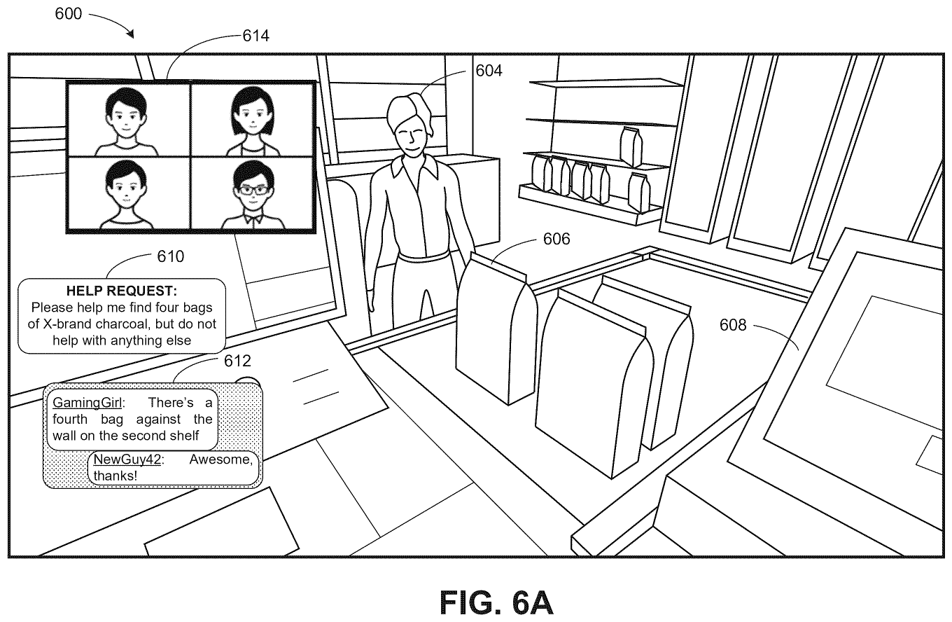

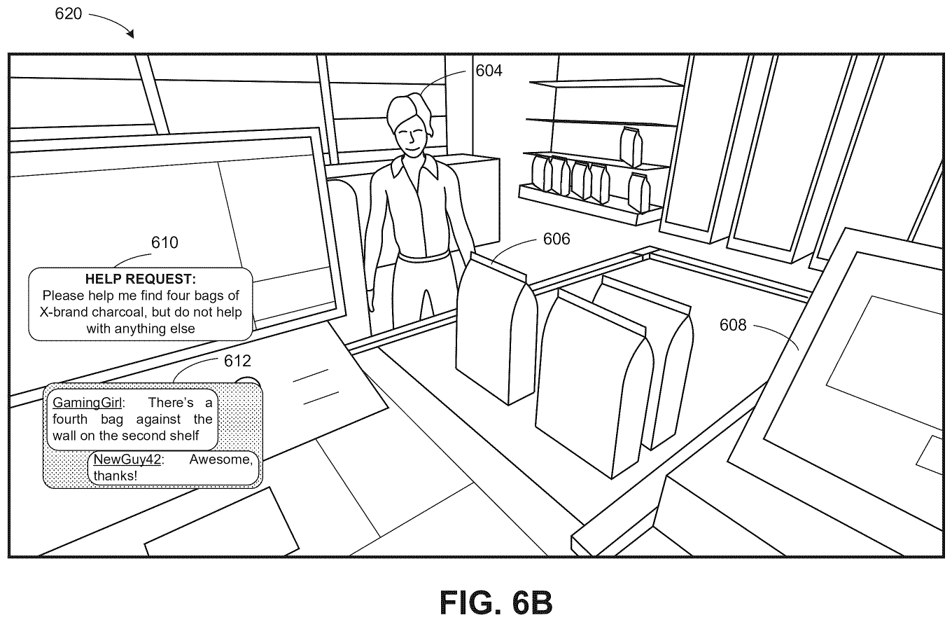

In some cases, a help session may involve a player specifying a limitation on what they would like help with. The following describes such an example. FIG. 6A is an illustration of a GUI 600 displaying a video game in which a game player stipulates what they want help with, as well as what they do not want a helper to do. Turning more particularly to the figure, the game player (NewGuy42) operates a virtual shopper 604 tasked with locating products 606 for purchase at a point of sale 608. The shopping can be timed for competitive considerations. The game player has chosen to initiate a help session using a dialogue box 610. In the scenario of FIG. 6A, the game player has written or spoken instructions specifying the parameters, or boundaries, of the requested help session. The game player has specified in natural language that they wish for help finding a product and do not want help with anything else. For example, the game player does not want help pushing a cart or chatting with a nonplayer character manning the register at the point of sale 608.

Accordingly, a chat log 612 is displayed with instructions from a helper to locate the product. The helper, GamingGirl, is restricted from assisting with any other aspect of the game. For instance, a multi-modal generative model could be employed to determine whether inputs received from GamingGirl are directed to finding charcoal, as requested, or other aspects of game play. Only those inputs directed to finding charcoal are actually passed to the game. After the helper assists in locating the product, the help session can be terminated automatically.

In some cases, a help session may result in a helper intentionally or unintentionally attempting to access privileged data. This can be prevented by controlling which outputs are provided to the helper. For instance, assume during the help session a window 614 is displayed to NewGuy42, and the window conveys a list of friends of NewGuy42. In some implementations, the window 614 is a system element that can be omitted from video output to GamingGirl. As shown in FIG. 6B, GamingGirl can be provided a GUI 620 that shows output from the video game but omits system elements such as window 614.

Similarly, screen sharing actions of other scenarios are restricted in a manner that shows a different screen to the helper than the video game player receiving assistance. In some implementations, video output is divided into multiple planes, such as by rendering a gaming plane having video output from the video game and a system plane having video output by an operating system or remote gaming service. For instance, the system plane can include overlays that access system functionality, such as window 614, that are displayed over the gaming plane. By sharing only a game plane view with the helper, the helper is prevented from seeing system elements that are shown on the screen of the player receiving assistance.

### Example Workflow

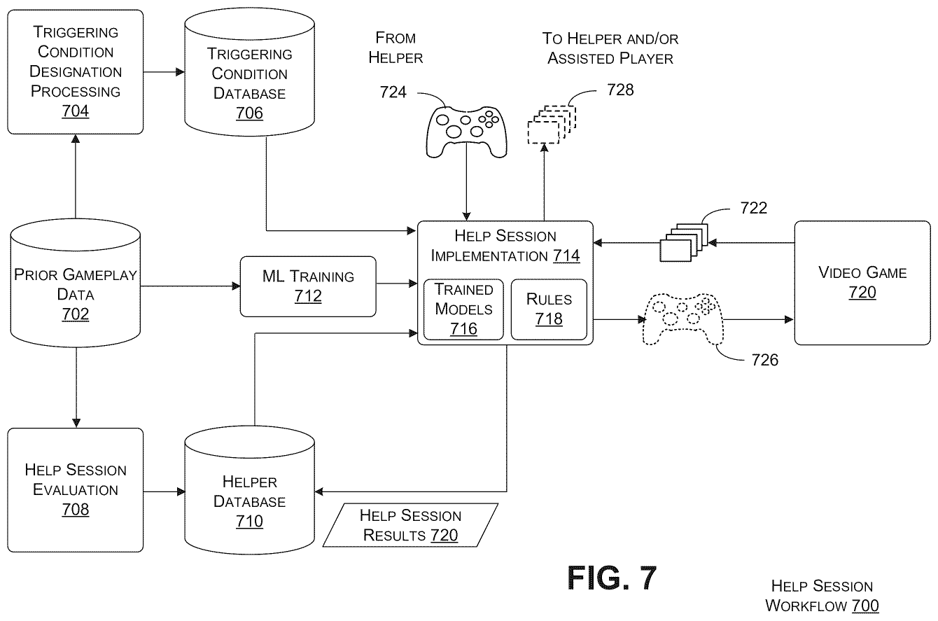

FIG. 7 shows an example help session workflow 700. Various sources of prior gameplay data 702 can be employed for designating help session triggering or ending conditions for a video game. The prior gameplay data can also be evaluated to evaluate video game helpers. For instance, the gameplay data can include gameplay sequences, communication logs, platform data, and instrumented game data, etc.

Gameplay sequences can include various sequences of video game outputs (video, audio, and/or haptic) and/or inputs obtained from one or more prior video gaming sessions. Optical character recognition can be performed on video frames in the gameplay sequences to obtain on-screen text features. In addition, machine learning can be performed on the video frames, audio output, and/or video game input to obtain ML-detected features. For instance, the ML-detected features can include object identifiers or embeddings obtained using computer vision model 204, described previously.

Communication logs can include chat or voice logs obtained during prior gaming sessions, e.g., communications between video game players when playing a particular video game. The communication logs can also include other types of communications, such as online forum discussions relating to a particular video game. The communication logs can be processed using natural language processing to obtain natural language processing features. For example, the natural language processing features can include sentiment relating to specific game scenarios.

Platform data can include data collected by a video gaming platform on which one or more video games can be executed. The platform data can include in-game achievements, saves, restarts, disengagement data, etc. The platform data can be processed using machine learning, rules, or statistical techniques to extract platform features.

Instrumented game data can include telemetry data collected by one or more video games. For example, games can track data such as levels completed, enemies defeated, etc. The instrumented game data can be processed using machine learning, rules, or statistical techniques to extract instrumented game data features.

The various features extracted from the prior gameplay data can be input to triggering condition designation processing 704. For instance, the triggering condition designation processing can involve applying one or more rules to the features to determine what conditions in a given video game will trigger a help session to begin and/or end. For instance, a rule could state that any condition that results in above a threshold percentage (e.g., 5%) of users disengaging after encountering that condition is designated as a help session triggering condition. In the examples above, the failure of a user to find a rare gem five times and then returning to the same location in the adventure game could be an example of a help session triggering condition. Similarly, a user crashing into a tree in a video game five times and then returning again to the same location on the track could be an example of a help session triggering condition.

In other cases, a machine learning model could be employed to designate help session triggering conditions. For instance, a generative language model or multi-modal generative model could be provided with features reflecting user disengagement (e.g., from platform data). As another example, a generative model could be provided features reflecting negative in-game consequences or difficult in-game goals. The generative model could identify these conditions as appropriate conditions for triggering help sessions. In some cases, rules and/or machine learning models can also be employed to designate help session ending conditions as well.

Once the help session triggering conditions have been designated, they can be used to populate a triggering condition database 706. The triggering condition database can include one or more help session triggering conditions (and possibly ending conditions) for one or more video games. Over time, the triggering condition database can evolve as circumstances change, such as updates to the video game(s).

In addition, the gameplay data can be processed by help session evaluation 708. In help session evaluation 708, the gameplay data for various help sessions is analyzed. A helper database 710 is populated based on the analysis. For instance, the helper database can include records for various video game helpers. The records can characterize how successful different video game helpers are on an overall basis, for specific video games, and/or at specific segments of video games, as described more below.

In addition, ML training 712 can train one or more machine learning models as described herein. The trained models can be employed to determine when a help session should be restricted (e.g., by preventing one or more control inputs from being provided to a video game) and/or ended. In addition, the trained models can be employed to detect help session triggering and/or ending conditions, to detect objects in output of a video game, etc.

As noted above, help session implementation 714 can involve determining whether a current gaming matches any of the triggering conditions in the triggering condition database 706. If so, then a help session can be initiated for the current video game player. The help session implementation can also involve determining when to end a help session, e.g., when a current video game player presses a specific button or buttons on their controller, or a help session ending condition is detected during gameplay. The help session implementation can also involve determining whether any helpers from helper database 710 are available and potentially selecting and/or ranking individual video game helpers for the help session.

Help session implementation 714 can employ the trained machine learning models 716 and/or one or more rules 718 to perform runtime restriction of inputs during a help session for video game 720. For instance, if a help session triggering condition is detected in output 722 of the video game, then a help session can be initiated. Helper inputs 724 can be received from a video game helper and can be restricted to obtain restricted inputs 726. In some cases, output 722 can also be restricted to obtain restricted output 728 (e.g., by masking a video feed to remove an in-game menu that performs restricted functionality).

The following describes just a few examples of inputs that can be restricted by rules or machine learning models using the disclosed techniques. As described above with respect to FIGS. 5A-5D, inventory modifications can be prevented. As another example, in-game settings menus can be restricted, e.g., a helper may be prevented from changing a player's controller settings, difficulty level, avatar, etc. As another example, a helper can be prevented from accessing prior save states of a game, and/or saving a current state of a game. In addition, system functionality that allows access to financial, personal, or friend information can also be restricted.

### Example System

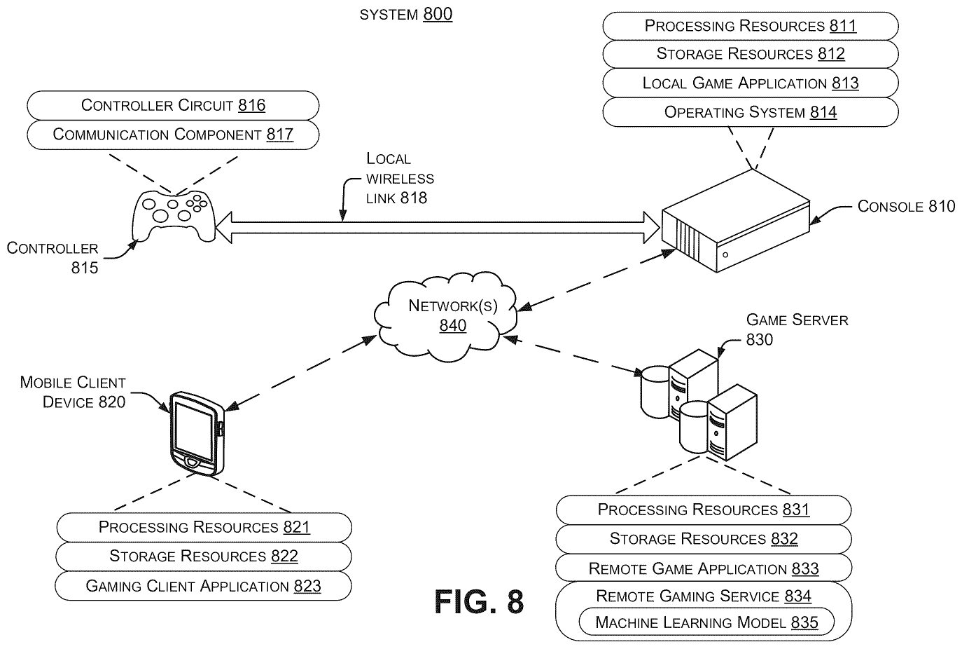

The present concepts can be implemented in various technical environments and on various devices. FIG. 8 shows an example system 800 in which the present concepts can be employed, as discussed below. As shown in FIG. 8, system 800 includes a console client device 810, a mobile client device 820, and a game server 830. Console client device 810, mobile client device 820, and server 830 are connected over one or more networks 840.

Console client device 810 can have processing resources 811 and storage resources 812, mobile client device 820 can have processing resources 821 and storage resources 822, and game server 830 can have processing resources 831 and storage resources 832. The devices of system 800 may also have various modules that function using the processing and storage resources to perform the techniques discussed herein, as discussed more below.

Console client device 810 can include a local game application 813 and an operating system 814. The local game application can execute using functionality provided by the operating system. The operating system can obtain control inputs from controller 815, which can include a controller circuit 816 and a communication component 817. The controller circuit can digitize inputs received by various controller mechanisms such as buttons or analog input mechanisms such as joysticks. The communication component can communicate the digitized inputs to the console client device over the local wireless link 818. The control interface module on the console can obtain the digitized inputs and provide them to the local application. The operating system can collect platform data during execution, and the game can collect instrumented game data during execution. As with previously described figures, the functions of the various components of the system can be dispersed throughout a network, be executed locally, or a combination of both.

Mobile client device 820 can have a gaming client application 823. The gaming client application can send inputs from a touchscreen on the mobile client device and/or peripheral game controller to the server 830, and can also receive game outputs, such as video, chat, and/or audio streams, from the server(s) and output them via a display, loudspeaker, headset, etc.

Server 830 can include a remote game application 833, which can correspond to a streaming version of a video game. The server 830 can also have a remote gaming service 834, which can execute the remote game application and provide various support services, such as maintaining user accounts, tracking achievements, etc. The remote game platform can also train a machine learning model 835 using prior gameplay data from help sessions for games offered by the platform and then execute the trained machine learning model to provide an automated help session.

When a help session is initiated for a game executed on the console client device 810, a cloud instance of a streaming version of the video game can be instantiated by the remote gaming service to provide a cloud-based help session. Then, the saved game state from the console can be used as an initial state for the help session, running on the cloud instance. When completed, the game state of the streaming session can be sent to the console, and the current user can resume gameplay from that state. In this case, the help session workflow 700 can be performed by the remote game service during the help session, e.g., by restricting which inputs received from a client device of the helper (such as mobile client device 820) are received by the game executing on the game server.

Various other execution scenarios are contemplated. For instance, some implementations can involve running an automated help session on another local console of the helper, and an operating system on the console of the helper can restrict inputs as described herein. Streaming output from the helper console can be sent over the network to the client device of the player receiving assistance. In other cases, both the current gaming session and the help session are streaming cloud instances of the video game. For help sessions involving local restriction of helper inputs, the game server 830 can distribute one or more trained machine learning models 835 to one or more client devices for local execution thereon. The trained machine learning models can be employed by the operating system on the client devices to trigger help sessions, end help sessions, and/or restrict help session inputs as described previously. In other cases, the remote gaming service and/or operating system can be programmed with one or more rules for restricting inputs during help sessions.

### Example Method

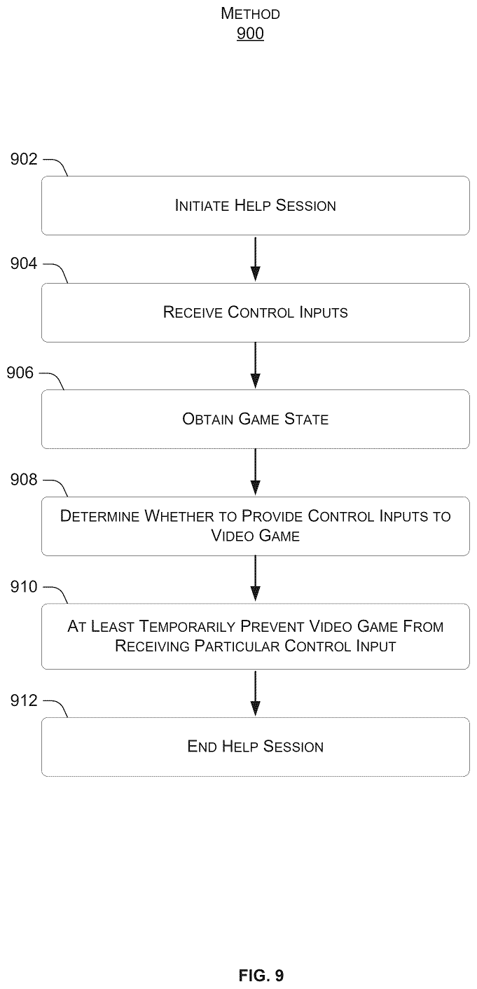

FIG. 9 illustrates an example computer-implemented method 900 for use in selectively and dynamically restricting helper access during a help session of a video game. As discussed herein, method 900 can be implemented on many different types of devices, e.g., by one or more cloud servers, by a client device such as a laptop, tablet, or smartphone, or by combinations of one or more servers, client devices, etc.

The method 900 begins at block 902, where the help session is initiated. For example, a help session can be initiated by a manual request from a current video game player, e.g., by pressing a designated sequence of buttons on a video game controller. In other examples, the help session is automatically initiated responsive to a triggering condition as described elsewhere herein, such as when the game player is identified to be struggling or is at a point in the video game where new game players are known to benefit from help.

The method 900 receives control inputs at block 904. The control inputs are received from a helper during a help session. The control inputs can include analog (e.g., joystick) inputs and/or button presses on video game controller, mouse and/or touch inputs, keyboard inputs, voice inputs, gestures (e.g., for a virtual reality headset), etc.

At block 906, the method 900 obtains the game state of the video game. The current game state may convey the current location of a character, items accrued in their inventory, health status, etc. In some cases, the game state is initially obtained via output of the video game and then processed (e.g., using a computer vision or multi-modal model) to determine objects present in the output.

At block 908, the method determines whether to provide control inputs to the game. For instance, in some cases, the determination is based on a rule, e.g., that a helper cannot modify inventory of a character without permission. In other cases, the determination is based on machine learning, e.g., the control inputs may be outliers compared to successful prior help session and/or determined to be likely to cause negative in-game consequences.

At block 910, the method at least temporarily prevents the game from receiving a particular input. For instance, if the particular input attempts to modify inventory of a character, then the player can be asked to confirm the inventory modification before providing the particular input to the game. If the particular input appears likely to result in a persistent negative in-game consequence, such as a car crash or death of a character, then the game can be paused, and the player can be notified that the help session is likely have a negative result.

At block 912, the help session is ended. For instance, the helper and/or assisted game player can end the help session using designated sequences of control inputs. In other cases, the help session can be ended when a help session ending condition is detected in output of the video game.

### Help Session Triggering and Ending Conditions

The following describes how various approaches can be employed to designate and/or detect help session triggering conditions in video games. Assume prior gameplay data 702 includes many video frames output by a racing game. There may be many crashes at various courses along the track, along with many successful instances of game players successfully navigating the track. The fact that a video game player happens to crash at a given location does not necessarily mean that location would be useful as a triggering condition for help sessions, e.g., if the vast majority of video game players do not crash at that location.

However, assume that there are many instances of video output in prior gameplay data 702 that look very similar to a particular crash sequence, where the driver crashes into a tree. Further, assume the platform data indicates significant disengagement that is temporally correlated with those gameplay sequences. In other words, users are frequently driving the car into the tree, then performing a restart of the driving game, switching to a different game, or stopping playing video games all together.

Further, assume that there are also a number of sequences of video output in gameplay data 702 where the driver successfully navigates the turn without crashing into the tree. Further, assume the platform data indicates very little disengagement that is temporally correlated with those gameplay sequences. In other words, after driving past the trees successfully, video game players are very rarely performing a restart of the driving game, switching to a different game, or stopping playing video games all together.

Using the example above, triggering condition designation processing 704 could designate a help session trigger condition occurring in the video driving game at a location on the track near where the crashes tend to occur. Since this location corresponds to a game circumstance that is strongly correlated with disengagement, it could be useful to offer help sessions to users when they appear to be struggling at this location on the road course. By looking at current session data, such as video output and input during a current gaming session, help session implementation 714 can detect the triggering condition and determine whether to offer the user a help session. For instance, the triggering condition could be detected by comparing one or more embeddings representing a current video frame to one or more embeddings representing a frame that is correlated with user disengagement. If the embeddings are sufficiently similar (e.g., within a threshold distance in a vector space) and the user has previously crashed into the tree a threshold number of times (e.g., five), then a help session can be triggered and then subsequently ended after the user successfully navigates past the tree. Note that it can be useful to initiate the help session somewhat before the negative in-game consequence tends to occur so that the helper has time to start playing the game and get acclimated to gameplay.

There are a wide range of techniques that can be employed for designating and detecting help session triggering conditions and help session ending conditions. The following illustrates just a few examples of how to do so.

First, consider a multi-modal generative model that has both computer vision and natural language capabilities. In some cases, numerous examples of video output of a video game could be sufficient for the multi-modal generative to identify that a help session is appropriate. For instance, a multi-modal generative could be trained with example sequences of video output and associated natural language data, such as user comments from a forum or chat log. The multi-modal generative could infer specific in-game conditions that tend to cause user comments to indicate disengagement, e.g., “I'm turning this off and going to bed,” and then the multi-modal generative could correlate those comments with specific video frames. Then, current video frames could be input to the multi-modal generative and the multi-modal model could indicate whether a help session should be triggered based on the current video frames. As but a few examples, a multi-modal generative could learn from training examples that a health bar is low, a user has crashed into a tree or been defeated in a fight, is struggling to find an item or complete a level, etc.

One way to obtain such a model is to start with a pretrained multi-modal generative model and provide training data for multiple games associated with a given genre. Since adventure and fighting games tend to have health bars and battles with enemies, racing games tend to have timers and crashes, etc., it is possible for a multi-modal generative to be tuned to a specific game genre. For instance, a multi-modal generative model could have a transformer architecture that represents images and language tokens in a shared vector space, where images and tokens representing similar concepts are located close together in the vector space and images and tokens representing dissimilar concepts can be located far apart in the vector space. A similar approach can also be implemented by tuning separate computer vision and generative language models using training data for games from a given genre. For instance, a computer vision model could output classifications of objects detected in video frames, and those classifications could be provided to a separate generative language model that has been tuned to detect game difficulty, disengagement, and/or negative in-game consequences based on the classification identified by the computer vision model.

In some cases, a multi-modal generative can be prompted to characterize a given in-game condition. For instance, a multi-modal generative could be prompted with a text description of a game provided by the game developer and one or more video frames, and the text description could allow the multi-modal generative model to more accurately understand what is being shown in video frames from that game. A similar technique could be performed by using a computer vision model to classify objects in a video frame and then input the names of those objects to a generative language model with the text description of the game.

In still further cases, a generative model can be employed to generate a natural language description of an in-game condition. For instance, the natural language could be “the user is approaching a stairway with a wall to their right.” This text description can be correlated to in-game goals such as finding a rare gem, and then a help session triggering condition can be represented using the text description. In some cases, transcripts of video tutorials, forum discussions, and/or in-game chat or voice transcripts can also be input to a generative model to learn which in-game conditions tend to drive disengagement.

Generative models can also determine from prior gameplay data how common certain achievements are, how different audio or controller inputs sequences may correlate to user disengagement, etc. Generative models could also output descriptions of an in-game scenario, e.g., “the user is about to be defeated by a boss on top of a stone bridge” or “the user is having a hard time finding the rare gem on level 7.” These descriptions could be used to trigger help sessions.

In some cases, generative models can also be employed to detect help session ending conditions. For instance, if a given segment of gameplay in prior gameplay data tends to end either with a crash into a tree or successfully navigating a turn, then successful navigation of the turn can be designated as an ending condition for help sessions. Likewise, if a given segment of gameplay tends to end with a user either moving too fast past a turn or slowing down for the turn and finding a rare gem, then finding the rare gem can be designated as an ending condition for help sessions. Models can also be tuned to select help session triggering conditions that occur early enough in gameplay so that the helper has time to react once gameplay begins.

In addition, some implementations can also determine the location of in-game elements such as gems, bosses, or places where frequent crashes occur. For instance, techniques such as photogrammetry or neural radiance fields can be employed to generate three-dimensional construction of a virtual scene provided by a video game. Help sessions can guide users to areas of the virtual scene where they may wish to achieve certain in-game goals.

In further cases, multi-modal generative models, vision models, and/or generative language models can be employed to designate help session triggering conditions and/or ending conditions, but other types of models are employed to detect those conditions during a current gaming session. For instance, a multi-modal generative model could identify a specific video frame as a help session triggering condition and another video frame as a help session ending condition, and embeddings of those video frames could be used to populate a triggering condition database. During gameplay, a smaller vision-only model could run periodically to generate embeddings of current video frames and compare them to the embeddings in the triggering condition database. A similar approach can be employed for audio or haptic output of a video game, and also for controller inputs to the video game. In other words, a help session triggering condition or ending condition could be represented using one or more of video embeddings, audio embeddings, haptic embeddings, and/or controller input sequences.

In further cases, a help session triggering condition can correspond to a video game player explicitly requesting help. For instance, a current video game player might enter text or voice stating, “I need help finding the rare gem near the staircase.” A trained machine learning model could interpret the input to correspond to a specific game segment of the adventure game, and initiate help session for that game segment.

### Additional Restriction Scenarios

The disclosed concepts can be implemented using a wide range of potential techniques in addition to those described above. For instance, video game players may have the flexibility to select how help sessions are restricted according to their own preferences. In some cases, some video game players may prefer not to have any restrictions at all. The operating system or remote gaming service may allow unrestricted help sessions with a few exceptions. For instance, the operating system or remote gaming service could always prevent access to financial information or personally identifiable information. In other cases, the operating system or remote gaming service can allow access to such information after explicit confirmation by the helpee each time access is requested by the helper.

In other cases, some video game payers may prefer to employ different restrictions in different help sessions. For instance, a helpee may choose to allow a trusted friend or relative to purchase inventory or adjust video game settings for an entire help session without receiving permission from the helpee. On the other hand, for a helper with which the helpee is not familiar, the helpee may prefer to restrict the help session so that inventory purchases or changes to game settings only occur if the helpee approves each individual inventory purchase or change to game settings.

### Technical Effect

As noted above, the disclosed implementations can be employed to automatically designate and detect help session triggering conditions. As a result, human-computer interaction can be improved by having a computer initiate a help session for a user. For instance, users may not be able to accurately determine when a help session is appropriate to initiate or to terminate. Using the disclosed techniques, specific in-game circumstances can be accurately detected and help sessions can be offered in a manner that encompasses scenarios where help is appropriate, based on prior interactions by other users with a given video game.

In further implementations, specific techniques can be employed to preserve processing, memory, and/or network bandwidth. For instance, some implementations can snapshot video output of a given game at a specified interval, e.g., every 30 seconds. Thus, instead of analyzing every video frame, far fewer frames are analyzed, and computing resources can be conserved. As another example of computing resource preservation, a large server-based generative model can be employed to evaluate massive amounts of prior gameplay data and designate help session triggering or ending conditions. Then, those conditions can be distributed to client devices where smaller (e.g., vision-only) models can detect the conditions in video game output and trigger help sessions.

In addition, the disclosed techniques also provide for automated restriction of help sessions in a manner that further improves human-computer interaction. Consider an alternative where video game helpers have unlimited ability to control a video game for another player during a help session. This could result in a variety of negative consequences, ranging from in-game problems such as crashes or deaths to accessing privileged information of the player receiving assistance. By restricting inputs (and, in some cases, outputs) during a help session, the disclosed implementations can help ensure security of privileged data while also improving human-computer interaction by mitigating unwanted helper actions during a help session.

### Device Implementations

As noted above, not all device implementations can be illustrated, and other device implementations than those described above with respect to FIG. 8 should be apparent to the skilled artisan from the description above and below. Thus, the terms “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions. When executed the computer-readable instructions can cause the hardware processors to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable medium” can include signals. In contrast, the term “computer-readable storage medium” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 840. Without limitation, network(s) 840 can include one or more local area networks (LANs), wide area networks (WANs), the Internet, and the like.

Various examples are described above. Additional examples are described below. One example includes a computer-implemented method comprising receiving control inputs from a helper during a help session for a video game, obtaining a game state of the video game, determining whether to provide the control inputs to the video game based on the game state, and in at least one instance, at least temporarily preventing the video game from receiving a particular control input received from the helper.

Another example can include any of the above and/or below examples where the method further comprises prompting a game player playing the video game to allow a restricted action associated with the particular control input, and responsive to receiving an affirmative response to the prompting, providing the particular control input to the video game.

Another example can include any of the above and/or below examples where the method further comprises prompting a game player playing the video game to allow a restricted action associated with the particular control input, and responsive to receiving a negative response to the prompting preventing the video game from receiving the particular control input, and notifying the helper that the restricted action has been prevented.

Another example can include any of the above and/or below examples where the method further comprises transferring control of the video game to the video game player responsive to receiving the negative response.

Another example can include any of the above and/or below examples where the method further comprises processing video output of the video game using a computer vision model, based on output of the computer vision model representing the game state, determining that the particular control input is directed to restricted video game functionality.

Another example can include any of the above and/or below examples where the restricted video game functionality involving modifying inventory of a character in the video game, accessing an in-game settings menu, or accessing one or more save states of the video game.

Another example can include any of the above and/or below examples where the determining is performed by inputting the control inputs and the game state to a trained machine learning model.

Another example can include any of the above and/or below examples where the trained machined learning model has been trained to perform control input classification using training data from one or more prior help sessions.

Another example can include any of the above and/or below examples where the trained machine learning model is a generative model that generates a characterization of the control inputs based on the game state.

Another example can include any of the above and/or below examples where the method further comprises determining that another control input received from the helper is directed to access of privileged data, and restricting the another control input.

Another example can include any of the above and/or below examples where the privileged data includes at least one of: financial information, personal information, and friend information.

Another example can include any of the above and/or below examples where the method further comprises restricting the video game from receiving the particular control input based on an assessment of the helper.

Another example can include any of the above and/or below examples where the method further comprises restricting the helper from accessing system functionality during the help session.

Another example can include any of the above and/or below examples where the method further comprises rendering a system plane and a game plane during the help session, the system plane including one or more graphical elements directed to system functionality and the game plane including one or more graphical elements directed to game functionality, outputting the system plane and the game plane on a client device of a current video game player receiving help during the help session, and outputting the game plane without the system plane on another client device of the helper during the help session.

Another example can include any of the above and/or below examples where the help session is a cloud-based help session and the control inputs are received from the another client device of the helper.

Another example can include a system comprising processing resources, and storage resources storing computer-readable instructions which, when executed by the processing resources, cause the processing resources to receive control inputs from a helper during a help session for a video game, obtain a game state of the video game, determine whether to provide the control inputs to the video game based on the game state, and in at least one instance, at least temporarily prevent the video game from receiving a particular control input received from the helper.

Another example can include any of the above and/or below examples where the computer-readable instructions, when executed by the processing resources, cause the processing resources to apply one or more rules to the control inputs to determine whether to provide the control inputs to the video game.

Another example can include any of the above and/or below examples where the computer-readable instructions, when executed by the processing resources, cause the processing resources to apply one or more machine learning models to the control inputs to determine whether to provide the control inputs to the video game.

Another example can include any of the above and/or below examples where provided on a server in communication with a client device of the helper and another client device of a current video game player receiving assistance via the help session.

Another example can include a computer-readable storage medium storing computer-readable instructions which, when executed by a hardware processing unit, cause the hardware processing unit to perform acts comprising receiving control inputs from a helper during a help session for a video game, obtaining a game state of the video game, determining whether to provide the control inputs to the video game based on the game state, and in at least one instance, at least temporarily preventing the video game from receiving a particular control input received from the helper.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
receiving control inputs from a helper during a help session for a video game;
obtaining a game state of the video game;
determining whether to provide the control inputs to the video game based on the game state; and
in at least one instance, at least temporarily preventing the video game from receiving a particular control input received from the helper.

2. The computer-implemented method of claim 1, further comprising:
prompting a game player playing the video game to allow a restricted action associated with the particular control input; and
responsive to receiving an affirmative response to the prompting, providing the particular control input to the video game.

3. The computer-implemented method of claim 1, further comprising:
prompting a game player playing the video game to allow a restricted action associated with the particular control input; and
responsive to receiving a negative response to the prompting:
preventing the video game from receiving the particular control input; and
notifying the helper that the restricted action has been prevented.

4. The computer-implemented method of claim 3, further comprising:
transferring control of the video game to the video game player responsive to receiving the negative response.

5. The computer-implemented method of claim 1, further comprising:
processing video output of the video game using a computer vision model;
based on output of the computer vision model representing the game state, determining that the particular control input is directed to restricted video game functionality.

6. The computer-implemented method of claim 5, the restricted video game functionality involving modifying inventory of a character in the video game, accessing an in-game settings menu, or accessing one or more save states of the video game.

7. The computer-implemented method of claim 1, wherein the determining is performed by:
inputting the control inputs and the game state to a trained machine learning model.

8. The computer-implemented method of claim 7, the trained machined learning model having been trained to perform control input classification using training data from one or more prior help sessions.

9. The computer-implemented method of claim 7, the trained machine learning model being a generative model that generates a characterization of the control inputs based on the game state.

10. The computer-implemented method of claim 1, further comprising:
determining that another control input received from the helper is directed to access of privileged data; and
restricting the another control input.

11. The computer-implemented method of claim 10, wherein the privileged data includes at least one of: financial information, personal information, and friend information.

12. The computer-implemented method of claim 1, further comprising:
restricting the video game from receiving the particular control input based on an assessment of the helper.

13. The computer-implemented method of claim 1, further comprising:
restricting the helper from accessing system functionality during the help session.

14. The computer-implemented method of claim 1, further comprising:
rendering a system plane and a game plane during the help session, the system plane including one or more graphical elements directed to system functionality and the game plane including one or more graphical elements directed to game functionality;
outputting the system plane and the game plane on a client device of a current video game player receiving help during the help session; and
outputting the game plane without the system plane on another client device of the helper during the help session.

15. The computer-implemented method of claim 14, wherein the help session is a cloud-based help session and the control inputs are received from the another client device of the helper.

16. A system comprising:
processing resources; and
storage resources storing computer-readable instructions which, when executed by the processing resources, cause the processing resources to:
receive control inputs from a helper during a help session for a video game;
obtain a game state of the video game;
determine whether to provide the control inputs to the video game based on the game state; and
in at least one instance, at least temporarily prevent the video game from receiving a particular control input received from the helper.

17. The system of claim 16, wherein the computer-readable instructions, when executed by the processing resources, cause the processing resources to:
apply one or more rules to the control inputs to determine whether to provide the control inputs to the video game.

18. The system of claim 16, wherein the computer-readable instructions, when executed by the processing resources, cause the processing resources to:
apply one or more machine learning models to the control inputs to determine whether to provide the control inputs to the video game.

19. The system of claim 16, provided on a server in communication with a client device of the helper and another client device of a current video game player receiving assistance via the help session.

20. A computer-readable storage medium storing computer-readable instructions which, when executed by a hardware processing unit, cause the hardware processing unit to perform acts comprising:
receiving control inputs from a helper during a help session for a video game;
obtaining a game state of the video game;
determining whether to provide the control inputs to the video game based on the game state; and
in at least one instance, at least temporarily preventing the video game from receiving a particular control input received from the helper.
